(19) United States
(12) Patent Application Publication
(10) Pub. No.: US 2016/0243651 A1
(43) Pub. Date: Aug. 25, 2016

(54) MATERIAL PROCESSING SYSTEM

(71) Applicant: Caterpillar Inc., Peoria, IL (US)

(72) Inventor: Andrew Douglas Steinmetz, Peoria, IL (US)

(73) Assignee: Caterpillar Inc., Peoria, IL (US)

(21) Appl. No.: 15/142,714

(22) Filed: Apr. 29, 2016

(51) Int. Cl. B23K 26/342; B23K 26/14; B23K 26/32

(52) U.S. Cl. CPC B23K 26/342; B23K 26/32; B23K 26/147

(57) ABSTRACT

A material processing system for a base material is provided. The material processing system includes a material feeder having a distal end proximate to a surface location of the base material. The material feeder supplies a cladding material to the surface location from the distal end. A laser source provides a laser beam. A processing head receives the laser beam from the laser source and directs the laser beam on the cladding material. A cartridge located in the processing head deflects the laser beam. The cartridge changes a power density distribution profile of the laser beam.

### TECHNICAL FIELD

The present invention relates to welding equipment and processes, and more particularly to laser cladding, also known as laser welding or additive manufacturing of a material that is deposited on a base material.

### BACKGROUND

Overlay welding or overlay hard-facing, otherwise known as cladding, involves the deposition of corrosion, erosion or wear resistant materials over a surface of a component to impart the beneficial properties of the cladding materials onto the surface of a metal component or part. The clad material is typically formed as a continuous clad coating of lateral overlapping beads, forming a pore-free, continuous surface of material that increases the thickness of the region. For remanufacturing of a worn part, a thin layer of worn-away material is replaced or a thin layer of the beneficial clad material is added to the workpiece. The industry is looking for methods of replacing worn-away metal or adding beneficial clad material without changing the part either dimensionally or materially by too much heat.

Laser cladding specifically address a need in all these areas by providing a low heat input, thin weld overlay, low dilution cladding. Laser cladding is a process in which the heat source is replaced by a laser which can be a CO2, Neodymium:YAG, fiber laser or diode laser. A laser focused as a line source is specifically well suited for wide thin laser cladding and the CO2, Nd:YAG, and fiber laser can be optically transformed to create such a line. Specifically, the diode laser has a naturally occurring spot that is a line with an approximate top hat profile that is very well suited for laser cladding that is preferably thin with low surface roughness and low dilution.

However, the top hat profile is not the ideal beam to achieve a top hat heating profile. An improved laser beam profile is that which has an intensity power distribution that is more intense at the outer regions. The heating profile also determines the melting profile during cladding. With a perfect top hat beam, the heat will be the greatest in the middle of the beam and taper off isotropically at the edges. This is even more pronounced using a standard Gaussian shaped beam which comes naturally from CO2, fiber coupled Nd:YAG, fiber lasers and diode lasers. Due to surface tension of the melt puddle, material factors, and type of cladding environments, such as cover gas, the resulting clad shape is rounded with a thicker center and tapering toward the ends (a lunular-type shape). This leads to undesirable surface morphology with humping in the middle of the clad track, which subsequently leads to large surface roughness and variable clad thickness during clad overlapping. It is desirable to be able to clad the base material with a uniform cladding material thickness from one clad track to the next. In addition, if the surface is at an edge it is desirable to pull the puddle to the edge without melting the edge. It is also desirable to be able to affect the weld puddle in real time to repair a clad while it is still in a molten or semi-molten state.

U.S. Application Publication No. 2013/0105447 relates to a material processing system for a workpiece, The system includes a primary laser source, a. secondary laser source, and a feeder proximate to a surface location of the workpiece. The feeder supplies a deposit material on a surface of the workpiece. The primary laser is directed to the deposit material at the surface of the workpiece, and is directed across the width from a main side to an auxiliary side. A secondary laser is directed to a desired location within the width of the deposit material to achieve a tailored and uniform cladding layer thickness in the workpiece. However, the primary laser and secondary laser may consume excessive power and also increases the equipment cost.

Hence, there is a need of an improved methodology to achieve uniform cladding layer thickness with good edge quality in the cladding layer of the workpiece with minimal power and minimal equipment cost.

### BRIEF DESCRIPTION OF THE DRAWINGS

FIG. 1 is a schematic of a material processing system for a base material in accordance with an embodiment of the present disclosure;

FIG. 2 is a side view of a processing head for the material processing system in accordance with an embodiment of the present disclosure;

FIG. 3 is a perspective view of a cartridge (multi-faceted prism) attached to the processing head of FIG. 2;

FIG. 4 is an exemplary power density distribution profile of an incident laser beam after passing through the cartridge in the processing head; and

FIG. 5 is another exemplary power density distribution profile of the incident laser beam after passing through the cartridge in the processing head.

### SUMMARY

In an aspect of the present disclosure, a material processing system for a base material is provided. The material processing system includes a material feeder having a distal end proximate to a surface location of the base material. The feeder supplies a cladding material to the surface location from the distal end. A laser source provides a laser beam. A processing head receives the laser beam from the laser source and directs the laser beam on the cladding material. A cartridge located in the processing head deflects the laser beam. The cartridge changes a power density distribution profile of the laser beam.

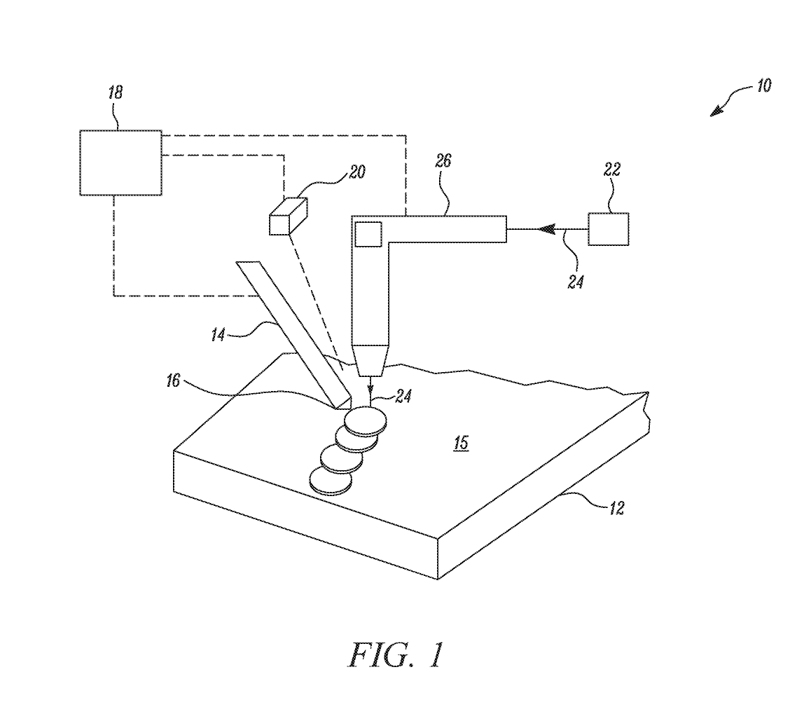

### DETAILED DESCRIPTION

Wherever possible, the same reference numbers will be used throughout the drawings to refer to same or like parts, FIG. 1 illustrates a material processing system 10. The material processing system 10 is a laser cladding system. Laser cladding is a method of depositing material by which a powdered or wire feedstock material is melted and consolidated by use of a laser in order to coat part of a substrate or fabricate a near-net shape part.

The material processing system 10 includes a workpiece 12 made of a base material. The base material may be any metal based material in accordance with the scope of the present disclosure. The workpiece 12 may he of any shape, size, dimensions as per the scope of the present disclosure. The workpiece 12 may have a single or multiple surfaces on which laser cladding has to be performed. A fixture (not shown) may hold the workpiece 12 in proper orientation for the laser cladding to be performed. The fixture may include means to locate and fix the workpiece 12 in multiple orientations. The fixture may also include means to rotate, translate or elevate the workpiece 12 in three dimensions.

The material processing system 10 further includes a material feeder 14. The material feeder 14 may be any conventional feeder capable of delivering a supply of a cladding material on a surface 15 of the workpiece 12. In the illustrated example, the material feeder 14 may deliver the cladding material in a powder form. However, it is contemplated that the material feeder 14 may also deliver the cladding material in other forms as well, such as in a wire form etc. In some applications, the material feeder 14 may additionally warm and/or engulf the cladding material in a shield gas as the cladding material is delivered. The material feeder 14 has a distal end 16 proximate to the surface 15 of the workpiece 12. The material feeder 14 supplies cladding material to the surface 15 of the workpiece 12 through the distal end 16.

The material processing system 10 further includes a controller 18. The controller 18 regulates a feed rate and/or angle of the cladding material supplied by the material feeder 14. As shown, the controller 18 is coupled to a sensor 20. The sensor 20 may be any type of sensor able to provide information about characteristics of a melt pool formed on the surface 15 of the workpiece 12. The sensor 20 may provide the controller 18 with information about the melt pool such as a thickness of the melt pool, surface finish of the melt pool etc. The controller 18 is also communicably coupled with the material feeder 14 and may provide instructions regarding controlling feed rate and/or angle of the cladding material being delivered at the surface 15 of the workpiece 12.

The material processing system 10 may further include a laser source 22. The laser source 22 may be, for example, a high-energy CO2 laser, ND:YAG laser, or any other type of solid-state, fiber-delivered laser capable of melting the cladding material as it is delivered at the surface 15 of the workpiece 12. In the illustrated embodiment, the laser source 22 is configured to produce a laser beam 24 having a generally circular or square shape. A dimension (For e.g., diameter) of the laser beam 24 may be provided so as to suit the need of the current application. The laser beam 24 may have a characteristic power density distribution across the diameter. The power density distribution may have a top-hat distribution profile, a Gaussian distribution profile etc. These power density distribution profiles are a characteristic property of the laser source 22. Such power density distribution profiles correspond to formation of a melt pool which has a higher concentration of thermal energy being supplied in center as compared to edges of the melt pool.

The power density distribution profile of the laser beam 24 determines shape, size and other characteristics of the melt pool. The top-hat profile or the Gaussian profile may lead to formation of a melt pool having thick material deposition in center and relatively thin material deposition at edges which may be undesirable. Therefore, the power density distribution profile of the laser beam 24 is altered by passing through a processing head 26.

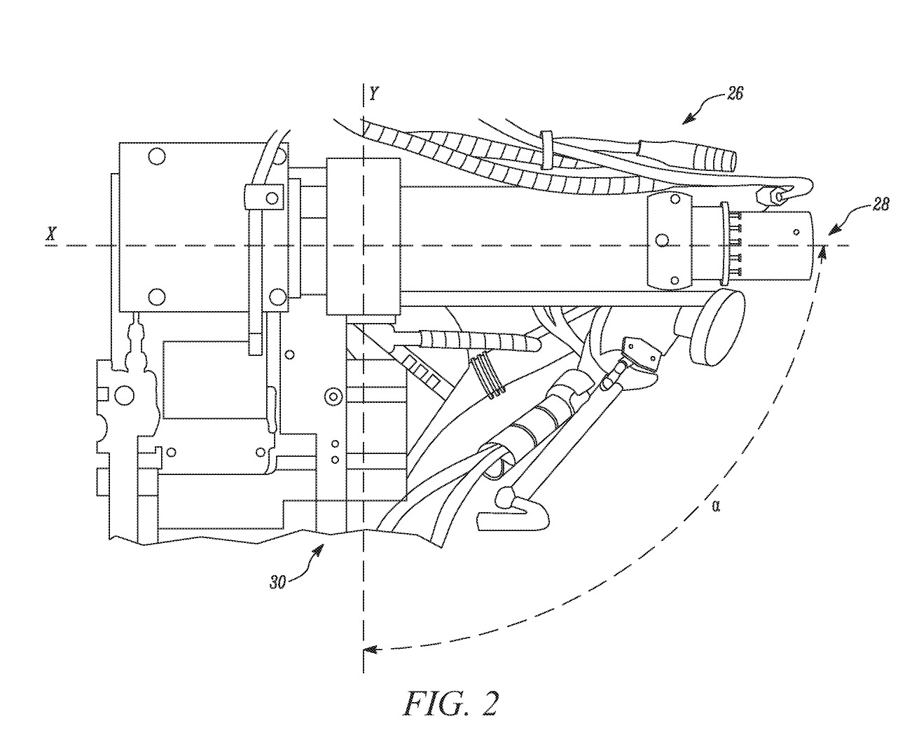

FIG. 2 illustrates the processing head 26. The processing head 26 receives the laser beam 24 and directs the laser beam 26 towards the surface 15 of the workpiece 12. The processing head 26 may include appropriate means of insulation to handle the laser beam 24. The processing head 26 may have multiple additional systems to handle the laser beam 24 such as cooling system etc. (not shown). The processing head 26 has a first end 28 and a second end 30. The first end 28 of the processing head 26 receives the laser beam 24. The second end 30 of the processing head 26 delivers the laser beam 24 at the surface 15 of the workpiece 12. It may also be contemplated that the processing head 26 may have the laser source 22 integrated with the processing head 26. A pair of axes is defined with respect to the first end 28 and the second end 30. X-axis is illustrated as passing through the first end 28 and parallel to the direction of incident laser beam 24. Y-axis is defined as passing through the second end and perpendicular to the X-axis.

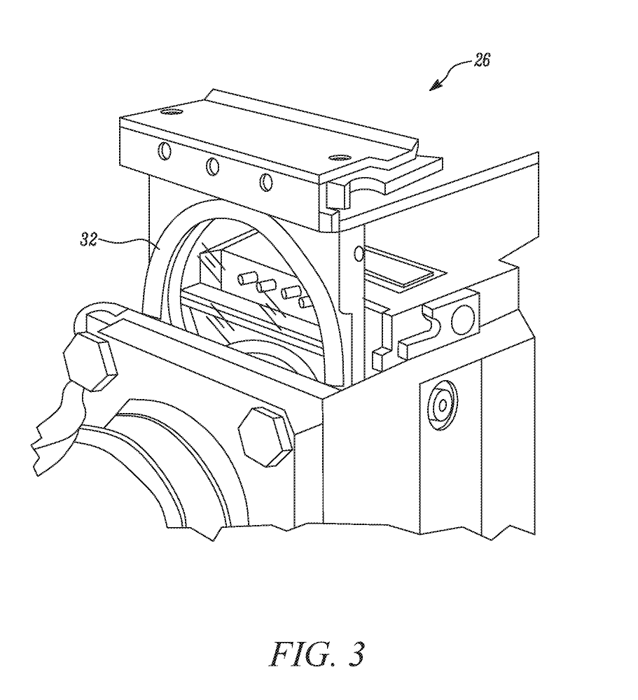

The first end 28 and the second end 30 may be oriented at an angle ‘α’ to each other. The angle ‘α’ is defined as the angle between X-axis and the Y-axis. Although, the angle ‘α’ is illustrated as ninety degrees, the angle ‘α’ may have any value in the range of zero to ninety degrees. The processing head 26 may include means to vary the angle ‘α’ as per the need of the application. The processing head 26 may be communicably coupled with the controller 18 to control the angle ‘α’. The processing head 26 may further include means to move the processing head 26 relative to the workpiece 12. The fixture and the processing head 26 may move together so as to cover all the surfaces of the workpiece 12 as required. The processing head 26 further includes a cartridge 32 (shown in FIG. 3) to deflect the laser beam 24 coming from the first end 28 towards the workpiece 12 through the second end 30.

FIG. 3 illustrates the cartridge 32 installed in the processing head 26. The cartridge 32 deflects the laser beam 24 towards the surface 15 of the workpiece 12. The cartridge 32 also modifies the power density distribution profile of the laser beam 24. The cartridge 32 may be a multi-faceted prism. A design of the prism defines the power density distribution profile of the laser beam 24. In various embodiments, the design of the prism may be varied so as to get a desired power density distribution profile of the laser beam 24 at the surface 15 of the workpiece 12.

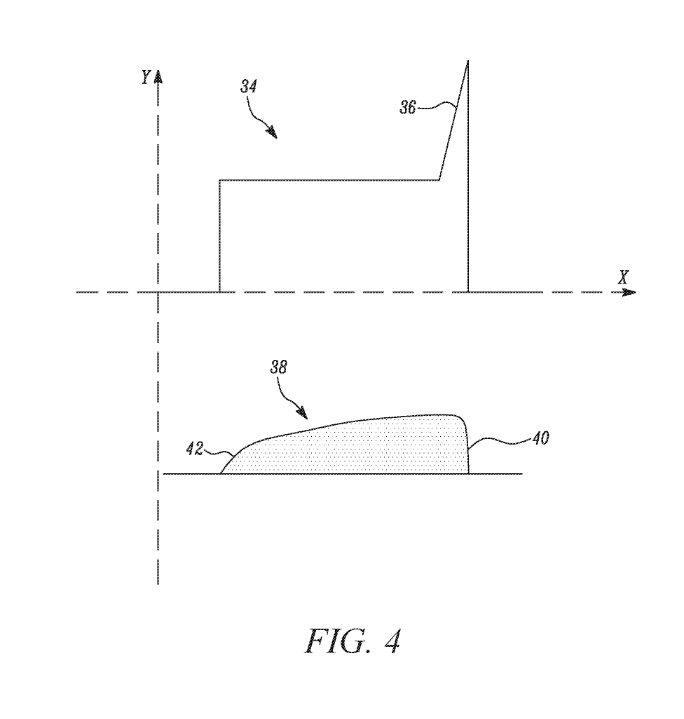

FIG. 4 represents a first exemplary power density distribution profile 34 for the laser beam 24. Power density distribution profile indicates power supplied to the surface 15 of the workpiece 12 by the laser beam 24 across the area of the melt pool. Y-axis represents the amount of power supplied to the surface 15 of the workpiece 12. X-axis represents the diameter of a melt pool formed over the surface 15 of the workpiece 12 at which laser beam 24 is supplying power. Therefore, a typical top-hat profile would represent higher amount of power being supplied in a middle region of a melt pool compared to the edges of the melt pool. Such a power density distribution profile would cause humping in the middle of the melt pool. The first profile 34 is similar to a top-hat profile. A spike 36 is provided towards the end. The spike 36 represents higher amount of power supplied at edges compared to middle region of the melt pool by the laser beam 24. A corresponding first melt pool shape 38 is also shown in FIG. 4. A first edge 40 of the melt pool corresponding to the spike 36 illustrates better dimensional accuracy compared to a second edge 42. More cladding material gets melted and thickness of the melt pool at the first edge 40 is almost equal to thickness of the melt pool at the middle.

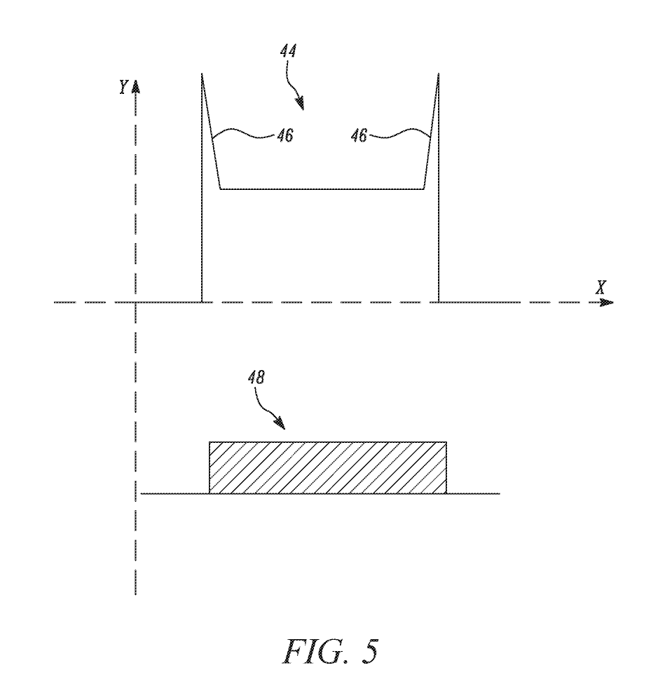

FIG. 5 shows a second improved power density distribution profile 44. The second profile 44 is also similar to a top-hat profile. As illustrated, the second profile 44 includes spikes 46 towards both the ends. The spikes 46 at the ends indicate higher intensity at edges of the laser beam 24. A corresponding second melt pool shape 48 is also shown in FIG. 5. Both the edges of the melt pool illustrate better dimensional accuracy. Thickness of the edges is almost the same as thickness of the central portion of the melt pool. Improved power density profiles provide for better dimensional accuracy as well as better rates of metal deposition. Further, post-machining required is also kept to a minimum.

The improved power density profiles 34, 44 illustrated in FIGS. 4 and 5 respectively correspond to different shapes of the multi-faceted prism being used as the cartridge 32. Different shape of the melt pool may be achieved by varying the shape of the prism. The prism may be easily replaced in the processing head 26. The appropriate prism is designed as per the application requirement and installed in the processing head 26. Although, the embodiments of the present disclosure have been explained by using a prism as the cartridge 32, any other optical element may also be utilized as the cartridge 32 to provide similar results.

### INDUSTRIAL APPLICATION

Laser cladding is an additive manufacturing process which deposits a powdered or wire cladding material on a metal surface. The cladding material is melted by use of a laser in order to coat a part of a substrate or fabricate a near net-shaped part. Laser cladding is often used to improve mechanical properties or increase corrosion resistance, repair worn out parts, and fabricate metal matrix composites. A major advantage provided by laser cladding is reduction in lead times and post-processing operations as compared to conventional manufacturing processes. However, laser cladding processes tend to lose this advantage on account of increased time in post-processing operations. Generally, the melt pool created by the laser cladding process appears to be thicker in center portion compared to edges. This occurs due to inherent power density distribution profiles of the laser beam.

The present disclosure overcomes the above-mentioned problem by providing means to modify the power density distribution profile of the laser beam 24. The power density distribution profile of the laser beam 24 is modified by passing the laser beam 24 through the processing head 26. The processing head 26 includes the first end 28 and the second end 30. The cartridge 32 is located between the first end 28 and the second end 30. The laser beam 24 enters the processing head 26 through the first end 28. The laser beam 24 passes through the cartridge 32. The power density distribution profile of the laser beam 24 is modified while passing through the cartridge 32. Thereafter, the laser beam 24 passes through the second end 30 of the processing head 26 and is directed towards the surface 15 of the workpiece 12.

The power density distribution profile of the laser beam 24 is modified in accordance with the shape of the cartridge 32. Different shapes of the cartridge 32 may be used to achieve various profiles at the workpiece 12. The exemplary profiles 34, 44 as shown in FIGS. 4 & 5 improve the properties of edge of the melt pool. Due to higher intensity of laser beam 24 at the edges, more cladding material is melted at the edges. Better dimensional accuracy is observed with the improved power density distribution profiles. Also, the shape of the melt pool may be varied as per the need of the application. Further, post-processing operations require lesser time. Little or no post-machining is required as the shape of the melt pool may be controlled in a better manner. Lesser number of passes is required to finish an operation. Thus, there is a reduction in total time required to repair or fabricate the workpiece 12, in turn causing cost savings.

While some of the solutions to the above-mentioned problem facilitate use of a secondary laser to improve the quality of laser cladding at edges, the present disclosure provides a solution without using a second laser. Apart from saving the cost of a second laser, the present disclosure also provides for a simple and less complex process apparatus. In absence of a second laser, the laser beam 24 and the workpiece 12 are provided with additional degrees of freedom relative to each other. Also, operational parameters of only a single laser are to be controlled compared to managing two separate lasers at a time.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A material processing system for a base material, the material processing system comprising:
a material feeder having a distal end proximate to a surface location of the base material, the material feeder configured to supply a cladding material to the surface location from the distal end;
a laser source configured to provide a laser beam;
a processing head adapted to receive the laser beam from the laser source and direct the laser beam on the cladding material; and
a cartridge disposed in the processing head to deflect the laser beam, the cartridge adapted to change a power density distribution profile of the laser beam.

2. The material processing system of claim 1, wherein the cartridge is a multi-faceted prism. The material processing system of claim 1, wherein the laser beam undergoes an angular deviation of 90 degrees while passing through the processing head.

4. The material processing system of claim 1, wherein the power density distribution profile of the laser beam is controlled such as to provide a relatively higher power density in proximity to at least one of a first edge and a second edge of a melt pool compared to a central position of the melt pool.

5. The material processing system of claim 4, wherein the relatively higher power density corresponds to a spike in the power density.

6. The material processing system of claim 5, wherein a first power density spike is located at the first edge of the melt pool.

7. The material processing system of claim 5, wherein a first power density spike is located at the first edge of the melt pool and a second power density spike is located at the second edge of the melt pool.
